(19) United States
(12) Patent Application Publication
(10) Pub. No.: US 2025/0181486 A1
(43) Pub. Date: Jun. 5, 2025

(54) AUTOMATED IDENTIFICATION AND MIGRATION OF INPUT AND BASELINE TEST DATA

(71) Applicant: Ab Initio Technology LLC, Lexington, MA (US)

(72) Inventors: Miranda Hawkins, Lexington, MA (US); Marshall A. Isman, Newton, MA (US); Maja Jankovic, Medford, MA (US); Alexander Samoylovich, Lexington, MA (US); Ben Hurd, Lexington, MA (US)

(21) Appl. No.: 18/962,909

(22) Filed: Nov. 27, 2024

Related U.S. Application Data
(60) Provisional application No. 63/605,262, filed on Dec. 1, 2023.

(51) Int. Cl. G06F 16/36

(52) U.S. Cl. CPC G06F 11/3684

(57) ABSTRACT

A computer-implemented method for defining a test for a computer program includes receiving operational data generated during execution of a computer program in a first computing environment, the operational data indicative of (i) a data source accessed by the computer program during execution of the computer program and (ii) a destination to where baseline data records are output by the computer program during execution of the computer program. Based on the received operational data, a data storage object is generated that includes (i) input data records from the data source and the baseline data records from the destination, and (ii) test definition data for the first computing environment. Responsive to migration of the computer program to a second computing environment, the input and baseline data records from the data storage object are stored in the second computing environment. A test configuration is defined for the migrated computer program in the second computing environment according to the test definition data in the data storage object and the mapping between the first computing environment and the second computing environment, the test configuration for the migrated computer program identifying a location of the input data records and a location of the baseline data records in the second computing environment. Execution of the migrated computer program in the second computing environment is tested using the input data records and baseline data records in the second computing environment and according to the defined test configuration for the migrated computer program.

### CLAIM OF PRIORITY

This application claims priority to U.S. Provisional Application Ser. No. 63/605,262, filed on Dec. 1, 2023, the contents of which are incorporated here by reference in their entirety.

### BACKGROUND

Testing of computer programs (e.g., executable dataflow graphs) following upgrades or migration from one environment to another (e.g., from a local system to the cloud) is important to ensure continued functionality of the programs.

### SUMMARY

We describe here systems and methods that automatically facilitate testing of changed computer programs, such as computer programs that have been upgraded or migrated from one environment to another. For instance, these approaches provide for identification and migration of test data in support of testing of computer programs that are migrated from an initial environment to a different, target environment.

When a computer program (e.g., a set of one or more graph, plans, or a combination thereof) is migrated from one environment to a different, target environment, the computer program is typically tested, e.g., using a testing utility, to ensure consistency of its functionality after the migration. However, manually identifying input and baseline test data to provide to the testing utility can be challenging and time consuming. In the approaches described here, these testing-related tasks area automated. For instance, the approaches described here automatically identify and collect test data, including input data used by the computer program and data output by the computer program, in the initial environment of the computer program. The test data are provided to the target environment, where the testing utility can use the test data to test the migrated computer program. These approaches can be implemented to confirm that a computer program is behaving as expected after its migration, e.g., that it produces outputs that are consistent with outputs that it produced in its original environment.

In an aspect, a computer-implemented method for defining a test for a computer program includes receiving operational data generated during execution of a computer program in a first computing environment, the operational data indicative of (i) a data source accessed by the computer program during execution of the computer program and (ii) a destination to where baseline data records are output by the computer program during execution of the computer program. The method includes, based on the received operational data, generating a data storage object including (i) input data records from the data source and the baseline data records from the destination, and (ii) test definition data indicative of a test configuration for the computer program in the first computing environment. The method includes, responsive to migration of the computer program to a second computing environment, storing the input data records and baseline data records from the data storage object in the second computing environment according to a mapping between the first computing environment and the second computing environment. The method includes defining a test configuration for the migrated computer program in the second computing environment according to the test definition data in the data storage object and the mapping between the first computing environment and the second computing environment, the test configuration for the migrated computer program identifying a location of the input data records and a location of the baseline data records in the second computing environment. Execution of the migrated computer program in the second computing environment is tested using the input data records and baseline data records in the second computing environment and according to the defined test configuration for the migrated computer program.

Embodiments can include one or any combination of two or more of the following features.

The operational data indicate that execution of the computer program modifies data records in the data source and the baseline data records include the modified data records in the data source. Generating the data storage object includes storing the input data records in the data storage object prior to execution of the computer program in the first computing environment, and storing the modified input data records in the data storage object following execution of the computer program in the first computing environment. In some cases, execution of the computer program modifies the input data records in the data source. In some cases, modification of data records in the data source by execution of the computer program includes generation of new data records in the data source. In some cases, modification of data records in the data source by execution of the computer program includes appending new data into a file of the data source.

The operational data are indicative of a path or location of each of the data source and the destination.

The method includes receiving the operational data during execution of the computer program.

Generating the data storage object includes storing a subset of data records from the data source in the data storage object, the subset of data records indicated by the operational data as having been accessed by the computer program during execution, and the subset of data records include the input data records.

The operational data are indicative of a record format of the input data records in the data source and a record format of the baseline data records in the destination. In some cases, the data storage object is generated to include data indicative of the record formats of the input and baseline data records.

Generating the data storage object includes generating a compressed archive file including the input data records, the baseline data records, and the test definition data.

The method includes storing the input data records and baseline data records in the second computing environment according to a mapping between a path or location in the first computing environment and a corresponding path or location in the second computing environment.

The method includes storing the input data records and baseline data records in the second computing environment according to a mapping between a record format of the input data records in the first computing environment and a record format for the input data records in the second computing environment, a record format of the baseline data records in the first computing environment and a record format for the baseline data records in the second computing environment, or both.

The defined test configuration for the migrated computer program includes one or more parameters specifying a comparison to be performed between the baseline data records and output data records generated by the migrated computer program processing the input data records.

The method includes testing the migrated computer program in the second computing environment. In some cases, testing the migrated computer program in the second computing environment includes processing, by the migrated computer program, the input data records stored in the second computing environment; outputting, from the migrated computer program, processed data records; and comparing the processed data records to the baseline data records stored in the second computing environment.

In an aspect, a non-transitory computer readable medium stores instructions that, when executed by one or more processors, cause the one or more processors to perform one or more of the above operations.

In an aspect, a computing system includes one or more processors coupled to a memory, the memory storing instructions that, when executed by the one or more processors, cause the one or more processors to perform one or more of the above operations.

The approaches described here can have one or more of the following advantages. The baseline data capture approaches described here are fast and efficient, e.g., avoiding a time consuming manual identification and porting of data from a source computing environment to a target computing environment. This speed advantage is particularly relevant for large migrations, e.g., for migration of computer programs that access and/or generate large amounts of data from/to large numbers of distinct locations. Moreover, these approaches are accurate, e.g., in that user involvement is minimal and thus the identification and porting of data is not subject to user error. Furthermore, these approaches are scalable for arbitrarily large migrations and/or datasets. These approaches are particularly relevant for porting dynamic data, soft links, and/or static code artifacts.

The details of one or more implementations are set forth in the accompanying drawings and the description below. Other features and advantages will be apparent from the description and drawings, and from the claims.

### BRIEF DESCRIPTION OF DRAWINGS

FIG. 1 is a schematic diagram of computer program migration.

FIG. 2 is a schematic diagram of a source computing environment.

FIG. 3 is a schematic diagram of a target computing environment.

FIG. 4 is a schematic diagram of a source computing environment.

FIGS. 5A-5B are process flow diagrams.

FIG. 6 is a flow chart.

FIG. 7 is a schematic diagram of a source computing environment.

FIG. 8 is a diagram of a computing system.

### DETAILED DESCRIPTION

We describe here systems and methods that automatically facilitate testing of migrated computer programs. More specifically, these approaches provide for identification and migration of test data in support of testing of computer programs that are migrated from an initial environment to a different, target environment.

When a computer program (e.g., a set of one or more graph, plans, or a combination thereof) is migrated (e.g., fully or in part) from one environment to a different, target environment, the computer program is typically tested, e.g., using a testing utility, to ensure consistency of its functionality after the migration. Similarly, following an upgrade, a computer program is often tested to ensure no undesired changes in functionality occurred as a result of the upgrade. However, manually identifying input and baseline test data to provide to the testing utility can be challenging and time consuming. In the approaches described here, these testing-related tasks area automated. For instance, the approaches described here automatically identify and collect test data, including input data used by the computer program and data output by the computer program, in the initial environment of the computer program. The test data are provided to the target environment, where the testing utility can use the test data to test the migrated computer program.

The approaches described here provide for automatic identification and migration of test data in support of testing of migrated computer programs. For instance, these approaches are relevant for testing of computer programs that are migrated (fully or in part) from a local computing environment (e.g., a legacy mainframe system) to a cloud-based or distributed computing environment, or vice versa (e.g., from a cloud-based or distributed environment to a local computing environment). These approaches are also relevant for testing of upgraded computer programs, e.g., where the source and the target environment are the same computing environment.

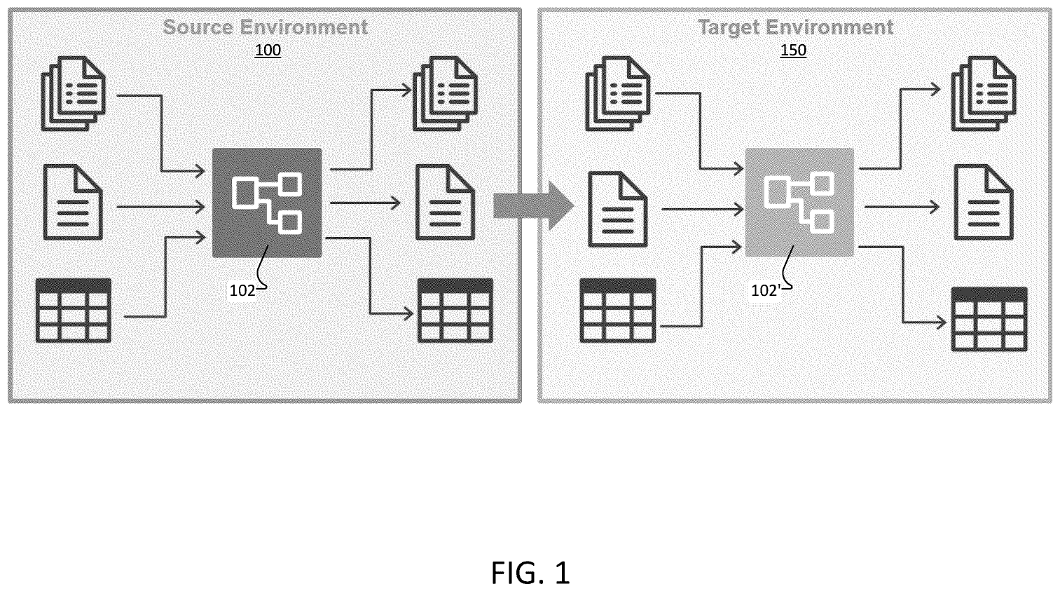

FIG. 1 is a schematic of computer program migration from a source computing environment 100 to a target computing environment 150, e.g., from a local, on-premises computing system to a cloud-based computing environment. Generally, the system obtains data operational metadata during execution of a baseline test of a computer program 102 in the source environment 100 and uses those metadata to automatically identify and collect test data, including input data used by the computer program 102 during execution in the source environment and baseline data output by the computer program 102 during execution. The system captures these collected test data into an archive data storage object, such as a compressed file, e.g., a tarball. The archive also can contain other metadata characterizing the test data, such as their record format, as well as data identifying the input and output data as input and baseline data, respectively, for a test of the computer program. The archive also includes parameters defining a test to be performed on the migrated computer program.

When the computer program is migrated to the target computing environment 150 as a migrated computer program 102′, the system unpacks the archive. For instance, the system stores input data and baseline data from the archive in locations in the target environment that are specified by a mapping between the source and the target environment. The testing utility then uses these unpacked test to test the migrated computer program. Specifically, the input data are processed by the migrated computer program 102′, and the output data generated by the migrated computer program 102′ are compared to the baseline data.

In some examples, the baseline testing of the computer program in the initial computing environment is performed on test input data that can replicate realistic input data (e.g., production data) that is typically processed by the computer program. The test input data are generally configured to invoke (test) one or more operations (e.g., each operation) that can be executed by the computer program to ensure that each invoked (tested) operation of the computer program is functioning as intended by the user. Output data are generated by the computer program by executing the operations on the test input data. These output data serve as baseline data to which subsequent output data are compared.

For instance, when the computer program is migrated to a target environment, the computer program is tested with the same test input data used for the baseline testing of the computer program in the source environment. Output data from this test in the target environment can be analyzed by the data processing system to determine whether the migrated computer program has operated as intended. For example, the output data of the computer program can be compared to the baseline output data generated by the test of the computer program in its source environment.

In a specific implementation, the approaches described here are relevant for testing of executable dataflow graphs. A dataflow graph is an executable computer program in the form of a graph that can include nodes, which are executable data processing components and data resources such as data sources and data sinks. Data resources can be, for example, files, database tables, or other types of data sources or sinks that can provide data (e.g., data records) for processing by the graph or receive data processed by the data processing components of the graph. Data processing components and data resources are sometimes collectively referred to as nodes of the graph. A link connecting two nodes of a graph is provided for a flow of information, such as data or control signals, between the nodes. Such dataflow graphs (sometimes referred to as graphs) can be data processing graphs or plans that control execution of one or more graphs. Dataflow graphs can be executed to carry out processing of the information. In some examples, one or more data processing components of a dataflow graph can be a sub-graph. The data processed by and output by dataflow graphs can be structured data, such as data records having values contained within fields.

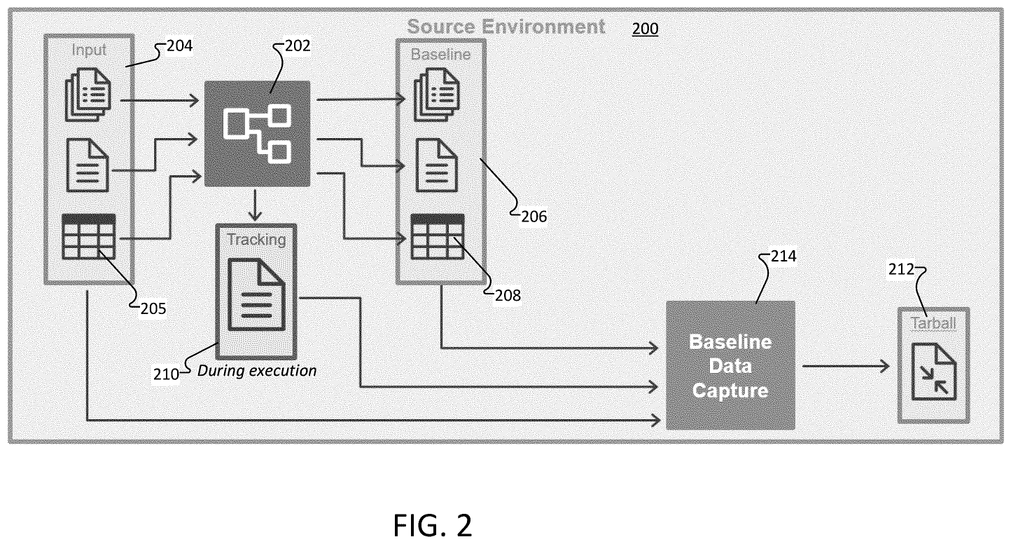

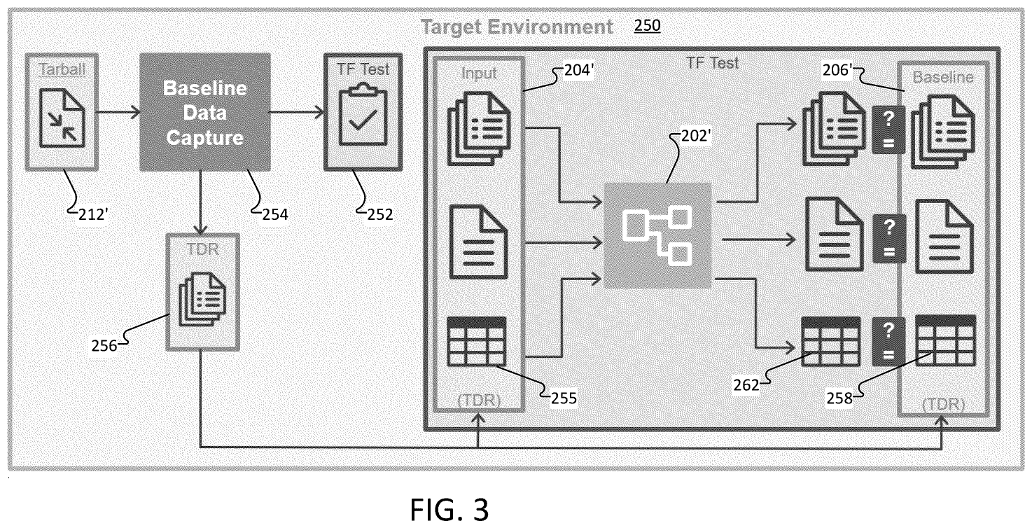

FIG. 2 illustrates an example schematic of operation of a baseline data capture utility for the identification of input and baseline test data for a computer program housed at a source computing environment 200, to be used for testing a migrated version of that computer program at a target computing environment 250 (see FIG. 3). The source computing environment 200 can be, for instance, a local (e.g., on-premises) computing system.

At the source computing environment 200, a baseline test is executed on a computer program 202. Execution of the baseline test includes the computer program 202 processing input data 204, such as data records having fields containing data, from one or more data sources 205 to generate baseline output data 206, such as data records, that serve as baseline data for future testing. The input data 204 are obtained by the computer program 202 from any suitable data source 205, such as files, tables, databases, queues, etc. Similarly, the baseline output data 206 are provided from the computer program 202 to any suitable destination 208, such as files, tables, databases, queues, etc. The input and output data can be in any suitable format that is compatible with operation of the computer program. The baseline output data 206 serve as an indication of current operation of the computer program 202. Future operation of migrated versions of the computer program can be evaluated by comparison of the baseline output data 206 to output data generated by running the same baseline test on those migrated versions.

Operational data 210 are collected during execution of the baseline test of the computer program 202. For instance, the operational data 210 are obtained from runtime log information that is generated during execution of the computer program.

The operational data 210 include data identifying or otherwise indicating the data source(s) 205 from where the input data 204 were obtained. The operational data 210 also include data identifying or otherwise indicating the destination(s) 208 where the baseline output data 206 are provided. For instance, the operational data 210 can indicate a location (e.g., path) of each data source 205 and destination 208.

In some examples, the operational data 210 include additional information about the input and/or output data 204, 206. For instance, the data source(s) 205 may contain more data than just the data accessed by the computer program 202 as the input data 204, meaning that the input data 204 are drawn from only a subset of the data contained in the data source(s) 205. The operational data 210 can include an indication of the subset of data (e.g., data records) from the data source(s) 205 that constitute the input data 204, e.g., the subset of data that were accessed by the computer program 202 during execution. Alternatively or additionally, the operational data 210 can include information indicative of a record format of data records at the data source(s) 205 and/or at the destination(s) 208.

A data storage object 212 is generated by a source instance 214 of the baseline data capture utility based on the operational data 210. The source instance 214 of the baseline data capture utility accesses the operational data 210, which provides an indication of the input data 204, and the baseline output data 206 to be used for generation, by the source instance 214, of the data storage object 212. Specifically, the data storage object 212 includes a copy of the input data 204 (referred to here as input data 204 for convenience) from the data source(s) 205 and a copy of the baseline output data 206 (referred to here as baseline output data 206) from the destination(s) 208, indicated by the operational data 210. In some examples, when the input data 204 constitutes only a subset of the data contained at the data source(s) 205, e.g., as indicated by the operational data 210, the data storage object 212 includes a copy of only that subset of data from the data source(s) 205.

The data storage object 212 also includes metadata about the input data 204 and/or baseline output data 206. For instance, when the operational data 210 include information indicative of a record format of data records at the data source(s) 205 and/or at the destination(s) 208, the data storage object 212 also includes record format information. Other relevant data contained in the operational data 210 can also be included in the generated data storage object 212.

The data storage object 212 also includes test definition data, e.g., in a test definition file. The test definition data indicate a test configuration that defines the baseline test that was executed on the computer program 202 in the source computing environment 200. The test configuration includes an indication of a location (e.g., a path) of the input data 204 to be provided to the computer program under test and the baseline output data 206 to be used as a reference to evaluate the output data generated by the computer program under test. In some examples, the test configuration can include other data for configuration or execution of the test. For instance, if the computer program references a reference data source such as a lookup table during execution, an indication of a location of the reference data source, or the reference data itself, is included in the test configuration. For example, if two data entries of the lookup table are accessed by the computer program during execution, the two accessed entries are stored in the data storage object 212 as elements of the test configuration.

In a specific example, the data storage object 212 is a compressed archive file, such as a tarball, that includes the input data 204, baseline output data 206, and test definition data, as well as other information captured by the operational data 210.

FIG. 3 illustrates an example schematic of operation of the baseline data capture utility at a target computing environment 250. The target computing environment 250 houses a migrated computer program 202′ that corresponds to the computer program 202 at the source computing environment 200 (FIG. 2).

The data storage object 212 is migrated to from the source computing environment 200 (FIG. 2) to the target computing environment 250, where it is referred to as a migrated data storage object 212′. A target instance 254 of the baseline data capture utility unpacks the migrated data storage object 212′ to retrieve test data 256 including the copies of the input data and baseline output data contained in the migrated data storage object 212′. The test data 256 are stored at locations 255, 258 in the target computing environment 250 as input data 204′ and baseline data 206′ at the target computing environment 250 according to a mapping between the source computing environment 200 and the target computing environment 250. The mapping can be a mapping between a location (e.g., a path) in the source computing environment 200 and a location (e.g., a path) in the target computing environment 250. Alternatively or additionally, the mapping can be a mapping between source formats, such as a mapping between a record format of input data records in the first computing environment and a record format for input data records in the target computing environment, a record format of baseline data records in the source computing environment and a record format for baseline data records in the target computing environment, or both.

The baseline data capture utility 254 also retrieves the test definition data from the data storage object 212 and defines a testing framework test 252 for the migrated computer program 202′ according to the test definition data and the mapping between the source computing environment 200 and the target computing environment 250. The testing framework test 252 includes parameters specifying aspects of the test. The parameters specify a location of the input data and a location of the baseline data in the target computing environment, e.g., as determined based on the information about the location of the input and baseline data in the source computing environment and the mapping between locations in the source and target computing environments. The parameters also specify one or more location(s) 262 for storage of output data generated during the test.

Parameter of the testing framework test 252 can also specify what the expected output of the tested logic should be from the processing of the input data during the test. When the test is executed, generated output data are compared to the baseline data. How closely the output data generated during the unit test matches the baseline data can be used as a metric for whether the unit test was passed or failed. The expected output can include a validation function that is specified by the test configuration. The validation function can include logic for testing one or more outputs generated from the unit test. The validation function can validate an output being in compliance with one or more rules for the output data, without necessarily specifying an exact value that should be included for each output. For example, the rules can specify that the output be a numerical value within an acceptable range, be an acceptable format, include a particular value, be a particular value, have valid data included (e.g., not be an empty or null value), and so forth. For example, if the output is known to be a social security number (SSN), the validation function can confirm that the output includes a valid social security number that is associated with a user identifier (or test identifier). Many other similar validation functions are possible.

Parameters of the testing framework test 252 can also specify additional elements of the test. One example of such a parameter is a test scheduling parameter that specifies when the test is to be executed. Another example of such a parameter is a specification of a type of test, e.g., whether the test is a test of the entire computer program or a unit test of only a subset of the computer program. Unit tests are described in U.S. Ser. No. 16/884,138 (“Unit Testing of Components of Dataflow Graphs”), the contents of which are incorporated here by reference in their entirety. Another example of such a parameter is a parameter specifying an output of the test, such as reporting data indicating whether the test was passed or failed and/or a detailed report on the outcome of the test (e.g., alignment between output data and baseline data).

A testing utility tests execution of the migrated computer program 202′ in the target computing environment 250 using the input data 204′ in the second computing environment 250 and according to the test configuration defined by the test definition data 252. Specifically, the migrated computer program 202′ processes the input data 204′ to generate output data 262, which are compared with the baseline data 206′ according to the specification of the test definition data 252. For instance, the testing utility can be implemented as a testing framework as described in U.S. Pat. No. 10,007,598 (“Data-Driven Testing Framework”), the contents of which are incorporated here by reference in their entirety.

Although the schematics of FIGS. 2 and 3 illustrate execution of a computer program represented by a single graph, the approaches described here are applicable to complex computer programs, e.g., computer programs encompassing large numbers of graphs and/or plans, and/or computer programs implemented via modalities other than graphs and plans. Moreover, although the schematics of FIGS. 2 and 3 illustrate execution of a dataflow graph, the baseline data capture approaches described here are applicable also to other types of computer programs.

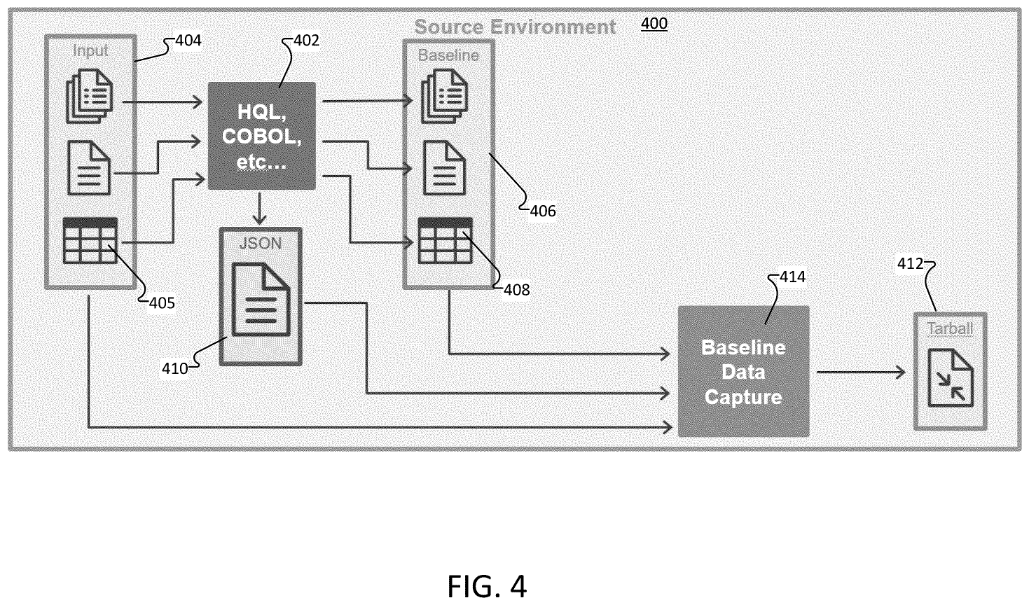

FIG. 4 is an schematic of operation of a baseline data capture utility at a source computing environment 400 in the context of a computer program 402 other than a dataflow graph, such as an HQL or COBOL program. The computer program 402 is executed in a baseline test to process input data 404 from one or more data sources 405 to generate baseline output data 406 that are stored at one or more destinations 408. An export utility capable of obtaining execution information from the computer program 402 collects operational data 410, e.g., in the form of a JSON file or other suitable log data, during execution of the baseline test of the computer program 402. A data storage object 414 is generated by a source instance 412 of the baseline data capture utility based on the operational data 410. The operational data 410 can contain information similar to that described above for the operational data 210. Once the computer program 402 is migrated to a target environment (not shown), the migrated computer program according to testing framework parameters and based on data contained in the data storage object 414, e.g., as also discussed above.

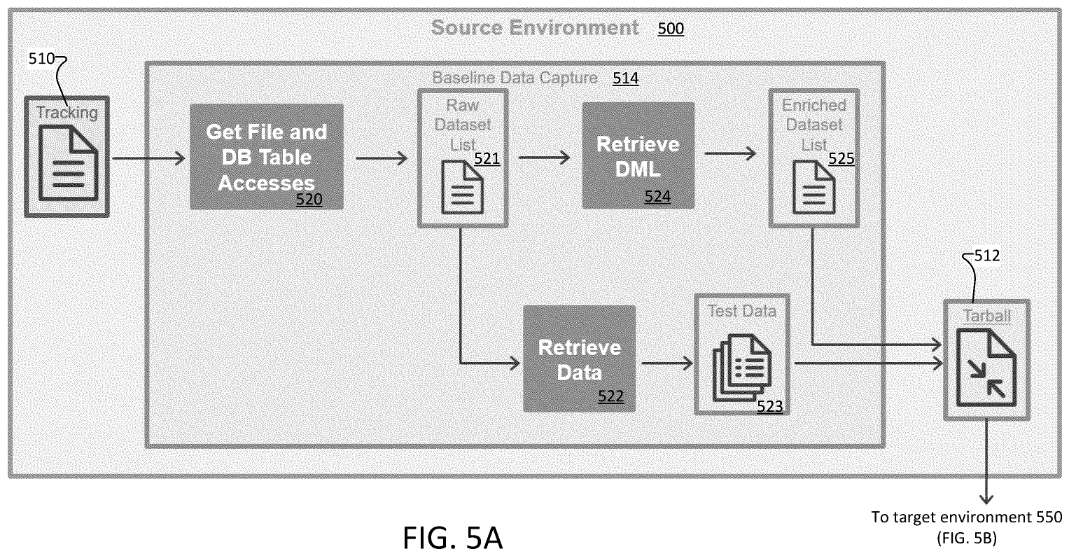

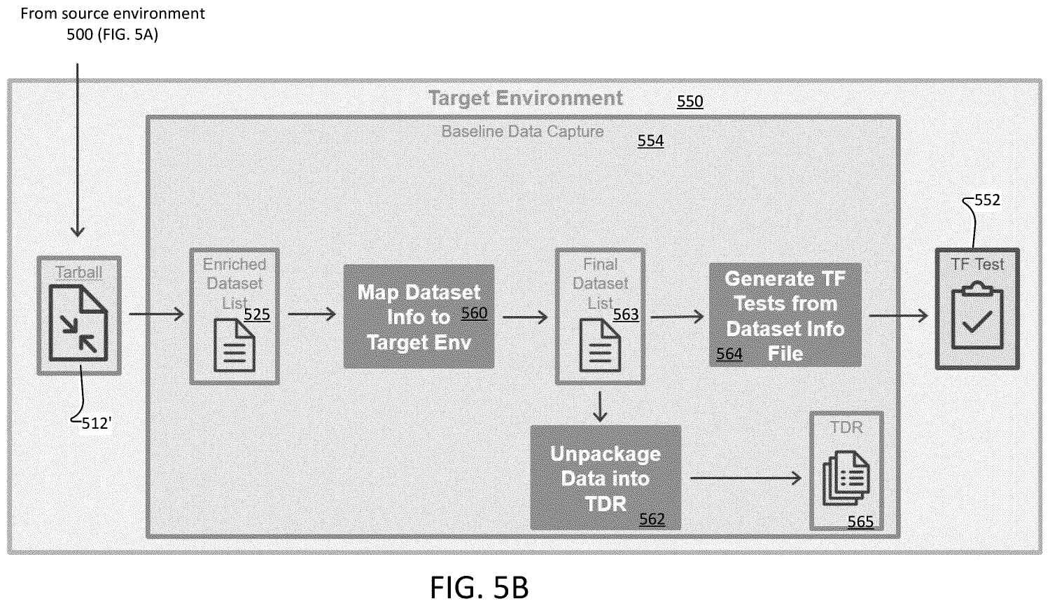

Referring to FIGS. 5A and 5B, in an example process flow for baseline data capture, a source instance 514 of a baseline data capture utility operates at the source computing environment 500 to generate a data storage object 512 (e.g., a tarball) based on operational data 510 collected during execution of the computer program at the source computing environment. In this process, data source information 521 about the data source(s) providing the input data for testing of the computer program and the destination(s) for the baseline output data is obtained (520). For instance, the data source information 521 can include file or database table information such as location (e.g., path), identifier (e.g., filename), or other information. Based on this data source information 521, the input data are retrieved from the data source(s) and the baseline output data are retrieved from the data source(s) (522) and copied as test data 523. An enriched dataset information file 525 is created (524) characterizing the datasets in the test data 523. The test data 523, dataset information file 525, along with test definition data, and, optionally, other metadata about the test data 523, such as source-target mappings, record format information, or other metadata, is archived, e.g., compressed, into the data storage object 512.

The data storage object 512 is migrated to a target computing environment 550 as a migrated data storage object 512′. At the target computing environment 550, a target instance 554 of the baseline data capture utility unpacks the migrated data storage object 512′ and maps (560) the dataset information file 525 to the target computing environment 550 according source-target mapping contained in the migrated data storage object 512′. A target environment list 563 is generated based on this mapping. The test data (e.g., copies of the input and baseline output data) contained in the data storage object 512′ are unpacked and stored as test data 565 in the target computing environment at locations specified by the mapping (562). A testing framework test 552 is defined (564) according to the dataset information file 525 and other information from the migrated data storage object 512′, such as test definition data, source-target mappings, record formation information, etc.

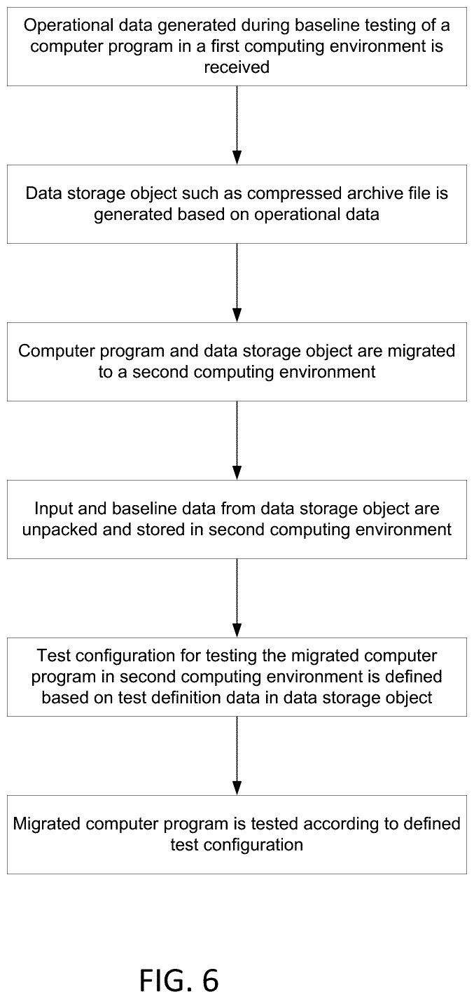

FIG. 6 is a flow chart of a process for defining a test for a computer program, e.g., a that is migrated from one computing environment to another.

In this process, operational data generated during execution of a baseline test of the computer program in a first computing environment is received (600). The operational data is received during execution of the baseline test. The operational data indicates (e.g., identifies, such as by name and/or location) a data source accessed by the computer program during execution of the computer program, e.g., to obtain input data such as input data records. The operational data also indicates (e.g., identifies, such as by name and/or location) a destination to where baseline data such as baseline data records are output by the computer program during execution of the computer program.

Based on the received operational data, a data storage object is generated (602). The data storage object can be a compressed archive file such as a tarball. The data storage object includes input data (e.g., input data records) from the data source indicated by the operational data, such as the input data from the data source that was accessed by the computer program during execution of the baseline test. The data storage object also includes baseline data (e.g., baseline data records) at the destination indicated by the operational data. The data storage object also includes test definition data indicative of a configuration for the baseline test of the computer program in the first computing environment.

The computer program is migrated to a second computing environment along with the data storage object (604). The input data and baseline data contained in the data storage object are unpacked and stored at the second computing environment in a location that is specified by a mapping between the first computing environment and the second computing environment (606).

A test configuration for a test of the migrated computer program is defined based on the test definition data contained in the data storage object, and based on the mapping between the first computing environment and the second computing environment (608). The test configuration specifies the location, in the second computing environment, of the input data to be used to test the migrated computer program, and the baseline data to be used for evaluation of the results of testing the migrated computer program.

The migrated computer program is tested according to the defined test configuration (610), using the input data as input, and comparing the output data from the test to the baseline data. The test confirmation can include parameters that specify a comparison to be performed between the baseline data and the output data generated during the test of the migrated computer program, e.g., for evaluation of the performance of the migrated computer program. For instance, the parameters can specify a threshold degree of similarity that, if not met, indicates that the migrated computer program is not performing as expected. If the test is not successful (e.g., if the output data is not sufficiently similar to the baseline data), a notification can be generated to alert an operator to the possibility that an error may have occurred during the migration.

In some examples, the computer program is configured such that the output data generated by execution of the computer program modifies the data source(s) containing the input data obtained by the computer program during execution. For instance, the computer program can overwrite data at the data source, generate additional data records in a table or database at the data source, append new data into a file or table at the data source, or otherwise modify the data at the data source. In these cases, the input data are copied into the data storage object prior to execution of the baseline test of the computer program, and the baseline output data are copied into the data storage object after execution of the baseline test.

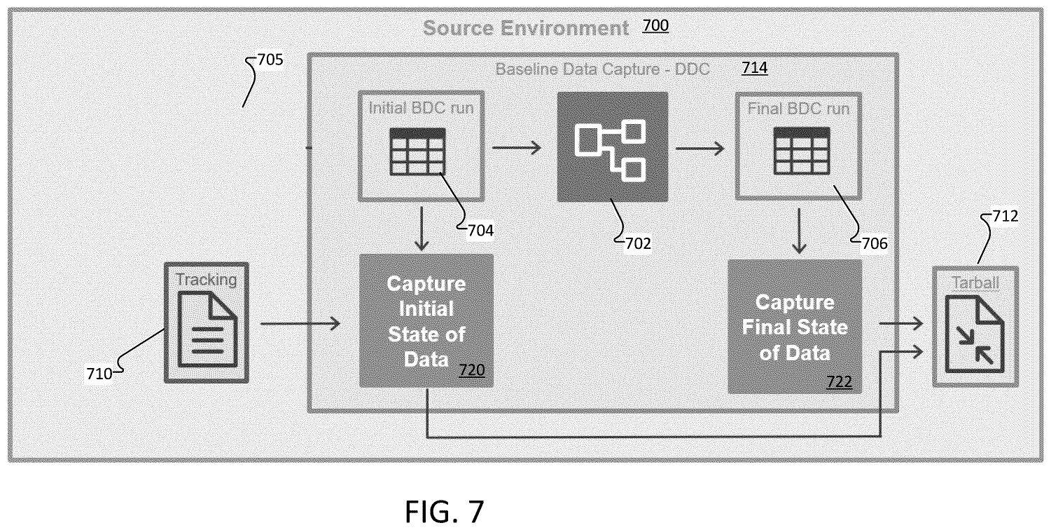

FIG. 7 illustrates a schematic implementation of an approach to baseline data capture at a source computing environment 700 that is applicable to this situation. Generally, in this approach, an initial data capture of the data at the data source is obtained prior to execution of the baseline test of the computer program, and a second data capture of data at the data source is obtained following execution of the baseline test of the computer program. Initiation of this approach is prompted by tracking information produced during a previous execution of a computer program. The tracking information, e.g., a log file, indicates that a location of input data 704 for a computer program 702 and a location for data 706 output by the computer program 702 are the same, and thus that input data are modified (e.g., overwritten or augmented) during execution of the computer program. For instance, the location of input data may be the same as the location of output data if the data source is a database.

Based on the tracking information indicating that input data are modified during computer program execution, an initial operation 720 of a source instance 714 of a baseline data is executed prior to a subsequent, baseline execution of the computer program 702. The initial operation 720 captures input data 704 from the data source indicated by the tracking information prior to execution of the baseline test of the computer program 702. A data storage object 712 is generated by the source instance 714 of the baseline capture utility, and a copy of the input data 704 captured from the data source prior to execution of the baseline test is stored in the data storage object 712. These data are indicated as input data to be used for testing of the migrated computer program.

Once the input data 704 have been, a baseline test is executed on the computer program 702. Execution of the baseline test includes the computer program 702 processing the input data 704 to generate baseline output data 706 that serve as baseline data for future testing. The baseline output data 706 is stored, at least in part, in one or more of the same data source(s) that supply the input data, e.g., by modifying (e.g., overwriting or augmenting) the input data 704.

Following execution of the baseline test, the baseline output data 706 is again captured in a second operation 722 of the source instance 714 of the baseline data capture utility. A copy of the baseline output data 706 is added to the data storage object 712 and indicated as baseline output data to be used for evaluation of the results of testing the migrated computer program.

The data storage object 712 further contains operational data, e.g., as discussed above for FIG. 2. For instance, the operational data include data identifying or otherwise indicating the data source(s) from where the input data 704 were obtained, and where the baseline output data 706 are stored, and other information, such as metadata about the input data 704 and/or output data 706, e.g., as discussed above for the operational data 210. The data storage object 712 is compressed and used for definition of a test in a target environment as described above in conjunction with FIG. 3.

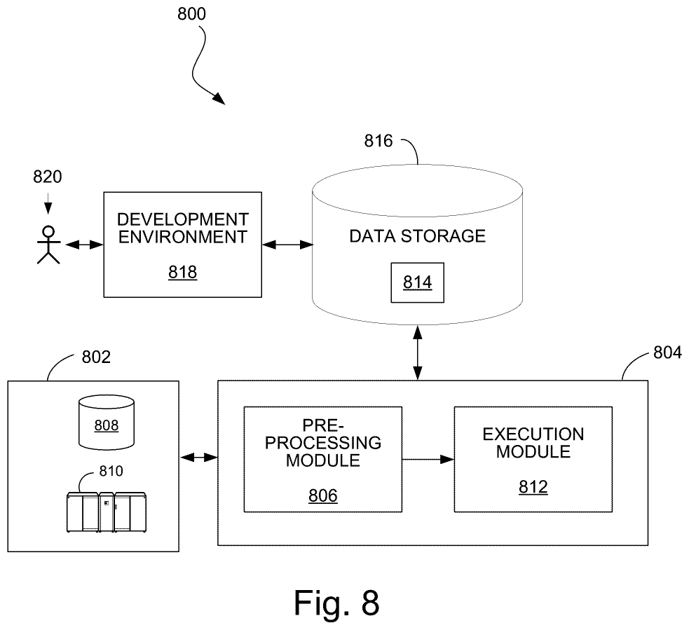

FIG. 8 shows an example of a data processing system 800 for developing and executing dataflow graphs in which the techniques described here can be used. The system 800 includes a data source 802 that may include one or more sources of data such as storage devices or connections to online data streams, each of which may store or provide data in any of a variety of formats (e.g., database tables, spreadsheet files, flat text files, or a native format used by a mainframe computer). The data may be logistical data, analytic data or industrial machine data. An execution environment or runtime environment 804 includes a pre-processing module 806 and an execution module 812. The execution environment 804 may be hosted, for example, on one or more general-purpose computers under the control of a suitable operating system, such as a version of the UNIX operating system. For example, the execution environment 804 can include a multiple-node parallel computing environment including a configuration of computer systems using multiple processing units (such as central processing units, CPUs) or processor cores, either local (e.g., multiprocessor systems such as symmetric multi-processing (SMP) computers), or locally distributed (e.g., multiple processors coupled as clusters or massively parallel processing (MPP) systems, or remote, or remotely distributed (e.g., multiple processors coupled via a local area network (LAN) and/or wide-area network (WAN)), or any combination thereof.

Storage devices providing the data source 802 may be local to the execution environment 804, for example, being stored on a storage medium (e.g., hard drive 808) connected to a computer hosting the execution environment 804, or may be remote to the execution environment 804, for example, being hosted on a remote system (e.g., mainframe computer 810) in communication with a computer hosting the execution environment 804, over a remote connection (e.g., provided by a cloud computing infrastructure).

The pre-processing module 806 reads data from the data source 802 and prepares data processing applications (e.g. an executable dataflow graph) for execution. For instance, the pre-processing module 806 can compile the data processing application, store and/or load a compiled data processing application to and/or from a data storage system 816 accessible to the execution environment 804, and perform other tasks to prepare a data processing application for execution.

The execution module 812 executes the data processing application prepared by the pre-processing module 806 to process a set of data and generate output data 864 that results from the processing. The output data 814 may be stored back in the data source 802 or in a data storage system 816 accessible to the execution environment 804, or otherwise used. The data storage system 816 is also accessible to an optional development environment 818 in which a developer 820 is able to design and edit the data processing applications to be executed by the execution module 812. The development environment 818 is, in some implementations, a system for developing applications as dataflow graphs that include vertices (representing data processing components or datasets) connected by directed links (representing flows of work elements, i.e., data) between the vertices. For example, such an environment is described in more detail in U.S. Patent Publication No. 2007/0011668, titled “Managing Parameters for Graph-Based Applications,” the contents of which are incorporated here by reference in their entirety. A system for executing such graph-based computations is described in U.S. Pat. No. 5,966,072, titled “Executing Computations Expressed as Graphs,” the contents of which are incorporated here by reference in their entirety. Dataflow graphs made in accordance with this system provide methods for getting information into and out of individual processes represented by graph components, for moving information between the processes, and for defining a running order for the processes. This system includes algorithms that choose interprocess communication methods from any available methods (for example, communication paths according to the links of the graph can use TCP/IP or UNIX domain sockets, or use shared memory to pass data between the processes).

The pre-processing module 806 can receive data from a variety of types of systems that may embody the data source 802, including different forms of database systems. The data may be organized as records having values for respective fields (also called “attributes” or “columns”), including possibly null values. When first reading data from a data source, the pre-processing module 806 typically starts with some initial format information about records in that data source. In some circumstances, the record structure of the data source may not be known initially and may instead be determined after analysis of the data source or the data. The initial information about records can include, for example, the number of bits that represent a distinct value, the order of fields within a record, and the type of value (e.g., string, signed/unsigned integer) represented by the bits.

In other words, and generally applicable to executable dataflow graphs described herein, the executable dataflow graph implements a graph-based computation performed on data flowing from one or more input data sets of a data source 802 through the data processing components to one or more output data sets, wherein the dataflow graph is specified by data structures in the data storage 816, the dataflow graph having the nodes that are specified by the data structures and representing the data processing components connected by the one or more links, the links being specified by the data structures and representing data flows between the data processing components. The execution environment or runtime environment 804 is coupled to the data storage 814 and is hosted on one or more computers, the runtime environment 804 including the pre-processing module 806 configured to read the stored data structures specifying the dataflow graph and to allocate and configure system resources (e.g. processes, memory, CPUs, etc.) for performing the computation of the data processing components that are assigned to the dataflow graph by the pre-processing module 806, the runtime environment 804 including the execution module 812 to schedule and control execution of the computation of the data processing components. In other words, the runtime or execution environment 804 hosted on one or more computers is configured to read data from the data source 802 and to process the data using an executable computer program expressed in form of the dataflow graph.

The approaches described above can be implemented using a computing system executing suitable software. For example, the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more modules of a larger program, for example, that provides services related to the design, configuration, and execution of graphs. The modules of the program (e.g., elements of a graph) can be implemented as data structures or other organized data conforming to a data model stored in a data repository.

The software may be provided on a tangible, non-transitory medium, such as a CD-ROM or other computer-readable medium (e.g., readable by a general or special purpose computing system or device), or delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs) or dedicated, application-specific integrated circuits (ASICs). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The inventive system may also be considered to be implemented as a tangible, non-transitory medium, configured with a computer program, where the medium so configured causes a computer to operate in a specific and predefined manner to perform one or more of the processing steps described herein.

Particular embodiments of the subject matter have been described. Other embodiments are within the scope of the following claims.

What is claimed is:

1. A computer-implemented method for defining a test for a computer program, the method including:
receiving operational data generated during execution of a computer program in a first computing environment, the operational data indicative of (i) a data source accessed by the computer program during execution of the computer program and (ii) a destination to where baseline data records are output by the computer program during execution of the computer program;
based on the received operational data, generating a data storage object including (i) input data records from the data source and the baseline data records from the destination, and (ii) test definition data indicative of a test configuration for the computer program in the first computing environment;
responsive to migration of the computer program to a second computing environment, storing the input data records and baseline data records from the data storage object in the second computing environment according to a mapping between the first computing environment and the second computing environment;
defining a test configuration for the migrated computer program in the second computing environment according to the test definition data in the data storage object and the mapping between the first computing environment and the second computing environment, the test configuration for the migrated computer program identifying a location of the input data records and a location of the baseline data records in the second computing environment;
whereby execution of the migrated computer program in the second computing environment is tested using the input data records and baseline data records in the second computing environment and according to the defined test configuration for the migrated computer program.

2. The method of claim 1, wherein the operational data indicate that execution of the computer program modifies data records in the data source and wherein the baseline data records include the modified data records in the data source, and wherein generating the data storage object comprises:
storing the input data records in the data storage object prior to execution of the computer program in the first computing environment, and
storing the modified input data records in the data storage object following execution of the computer program in the first computing environment.

3. The method of claim 2, wherein execution of the computer program modifies the input data records in the data source.

4. The method of claim 2, wherein modification of data records in the data source by execution of the computer program includes generation of new data records in the data source.

5. The method of claim 2, wherein modification of data records in the data source by execution of the computer program includes appending new data into a file of the data source.

6. The method of claim 1, wherein the operational data are indicative of a path or location of each of the data source and the destination.

7. The method of claim 1, including receiving the operational data during execution of the computer program.

8. The method of claim 1, wherein generating the data storage object includes storing a subset of data records from the data source in the data storage object, the subset of data records indicated by the operational data as having been accessed by the computer program during execution, and wherein the subset of data records comprise the input data records.

9. The method of claim 1, wherein the operational data are indicative of a record format of the input data records in the data source and a record format of the baseline data records in the destination.

10. The method of claim 9, wherein the data storage object is generated to include data indicative of the record formats of the input and baseline data records.

11. The method of claim 1, wherein generating the data storage object includes generating a compressed archive file including the input data records, the baseline data records, and the test definition data.

12. The method of claim 1, including storing the input data records and baseline data records in the second computing environment according to a mapping between a path or location in the first computing environment and a corresponding path or location in the second computing environment.

13. The method of claim 1, including storing the input data records and baseline data records in the second computing environment according to a mapping between a record format of the input data records in the first computing environment and a record format for the input data records in the second computing environment, a record format of the baseline data records in the first computing environment and a record format for the baseline data records in the second computing environment, or both.

14. The method of claim 1, wherein the defined test configuration for the migrated computer program includes one or more parameters specifying a comparison to be performed between the baseline data records and output data records generated by the migrated computer program processing the input data records.

15. The method of claim 1, including testing the migrated computer program in the second computing environment.

16. The method of claim 15, wherein testing the migrated computer program in the second computing environment includes:
processing, by the migrated computer program, the input data records stored in the second computing environment;
outputting, from the migrated computer program, processed data records; and
comparing the processed data records to the baseline data records stored in the second computing environment.

17. A non-transitory computer readable medium storing instructions that, when executed by one or more processors, cause the one or more processors to perform operations including:
receiving operational data generated during execution of a computer program in a first computing environment, the operational data indicative of (i) a data source accessed by the computer program during execution of the computer program and (ii) a destination to where baseline data records are output by the computer program during execution of the computer program;
based on the received operational data, generating a data storage object including (i) input data records from the data source and the baseline data records from the destination, and (ii) test definition data indicative of a test configuration for the computer program in the first computing environment;
responsive to migration of the computer program to a second computing environment, storing the input data records and baseline data records from the data storage object in the second computing environment according to a mapping between the first computing environment and the second computing environment;
defining a test configuration for the migrated computer program in the second computing environment according to the test definition data in the data storage object and the mapping between the first computing environment and the second computing environment, the test configuration for the migrated computer program identifying a location of the input data records and a location of the baseline data records in the second computing environment;
whereby execution of the migrated computer program in the second computing environment is tested using the input data records and baseline data records in the second computing environment and according to the defined test configuration for the migrated computer program.

18. The non-transitory computer readable medium of claim 17, wherein the operational data indicate that execution of the computer program modifies data records in the data source and wherein the baseline data records include the modified data records in the data source, and wherein generating the data storage object comprises:
storing the input data records in the data storage object prior to execution of the computer program in the first computing environment, and
storing the modified input data records in the data storage object following execution of the computer program in the first computing environment.

19. The non-transitory computer readable medium of claim 17, wherein the operational data are indicative of a path or location of each of the data source and the destination.

20. The non-transitory computer readable medium of claim 17, wherein generating the data storage object includes storing a subset of data records from the data source in the data storage object, the subset of data records indicated by the operational data as having been accessed by the computer program during execution, and wherein the subset of data records comprise the input data records.

21. The non-transitory computer readable medium of claim 17, wherein generating the data storage object includes generating a compressed archive file including the input data records, the baseline data records, and the test definition data.

22. The non-transitory computer readable medium of claim 17, wherein the defined test configuration for the migrated computer program includes one or more parameters specifying a comparison to be performed between the baseline data records and output data records generated by the migrated computer program processing the input data records.

23. The non-transitory computer readable medium of claim 17, wherein the operations include testing the migrated computer program in the second computing environment.

24. The non-transitory computer readable medium of claim 23, wherein testing the migrated computer program in the second computing environment includes:
processing, by the migrated computer program, the input data records stored in the second computing environment;
outputting, from the migrated computer program, processed data records; and
comparing the processed data records to the baseline data records stored in the second computing environment.

25. A computing system comprising one or more processors coupled to a memory, the memory storing instructions that, when executed by the one or more processors, cause the one or more processors to perform operations including:
receiving operational data generated during execution of a computer program in a first computing environment, the operational data indicative of (i) a data source accessed by the computer program during execution of the computer program and (ii) a destination to where baseline data records are output by the computer program during execution of the computer program;
based on the received operational data, generating a data storage object including (i) input data records from the data source and the baseline data records from the destination, and (ii) test definition data indicative of a test configuration for the computer program in the first computing environment;
responsive to migration of the computer program to a second computing environment, storing the input data records and baseline data records from the data storage object in the second computing environment according to a mapping between the first computing environment and the second computing environment;
defining a test configuration for the migrated computer program in the second computing environment according to the test definition data in the data storage object and the mapping between the first computing environment and the second computing environment, the test configuration for the migrated computer program identifying a location of the input data records and a location of the baseline data records in the second computing environment;
whereby execution of the migrated computer program in the second computing environment is tested using the input data records and baseline data records in the second computing environment and according to the defined test configuration for the migrated computer program.

26. The computing system of claim 25, wherein the operational data indicate that execution of the computer program modifies data records in the data source and wherein the baseline data records include the modified data records in the data source, and wherein generating the data storage object comprises:
storing the input data records in the data storage object prior to execution of the computer program in the first computing environment, and
storing the modified input data records in the data storage object following execution of the computer program in the first computing environment.

27. The computing system of claim 25, wherein the operational data are indicative of a path or location of each of the data source and the destination.

28. The computing system of claim 25, wherein generating the data storage object includes storing a subset of data records from the data source in the data storage object, the subset of data records indicated by the operational data as having been accessed by the computer program during execution, and wherein the subset of data records comprise the input data records.

29. The non-transitory computer readable medium of claim 17, wherein generating the data storage object includes generating a compressed archive file including the input data records, the baseline data records, and the test definition data.

30. The computing system of claim 25, wherein the defined test configuration for the migrated computer program includes one or more parameters specifying a comparison to be performed between the baseline data records and output data records generated by the migrated computer program processing the input data records.

31. The computing system of claim 25, wherein the operations include testing the migrated computer program in the second computing environment.

32. The computing system of claim 31, wherein testing the migrated computer program in the second computing environment includes:
processing, by the migrated computer program, the input data records stored in the second computing environment;
outputting, from the migrated computer program, processed data records; and
comparing the processed data records to the baseline data records stored in the second computing environment.
